(19) United States
(12) Patent Application Publication
(10) Pub. No.: US 2002/0001470 A1
(43) Pub. Date: Jan. 3, 2002

(54) Portable stand

(76) Inventor: Roger Linnecke, Vogtareuth (DE)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/859,970

(22) Filed: May 17, 2001

(30) Foreign Application Priority Data
May 18, 2000 (EP) 00110621.0

(51) Int. Cl. G03B 17/00

(52) U.S. Cl. 396/419

(57) ABSTRACT

The present invention relates to a portable stand, in particular a portable stand for holding and supporting video cameras, photo-cameras and other optical recording apparatus and devices, including an oblong basic body and a first handle, provided at one end of said basic body, as well as a connection plate, provided at the respective opposite end of said basic body, for holding the devices to be supported and carried, with a slidable arrest carriage which can be locked in position being provided between said first handle and said connection plate on said basic body and with a second, turning handle which runs in ball headed bearing means being movably mounted on said arrest carriage.

The present invention relates to a portable stand, in particular a portable stand for holding and supporting video cameras, photo-cameras and other optical recording apparatus and devices, comprising an oblong basic body and a first handle, provided at one end of said basic body, as well as a connection plate provided at the opposite end of said basic body for holding the device to be supported and carried.

Portable stands of this type are known from the prior art and are used especially for supporting cameras. For taking pictures and, in particular, for shooting videos or movies, it is desirable to take stills as well as shots in motion that are as steady and unblurred as possible. Furthermore, it should be possible to move the camera in all axial directions. For this purpose, prior art portable stands are equipped with at least one counterweight for balancing movements.

However, one shortcoming of such prior art portable stands is that the optically conspicuous counterweight will frequently extend far into the space, which makes it an obstacle strongly restricting the freedom of motion of the camera operator. Owing to the high total weight, such stands can only be carried for a short time which in turn considerably limits their application range.

It is therefore the object of the present invention to provide a portable stand of the aforementioned type which will overcome the abovementioned shortcomings of prior art stands and will allow steady and unblurred recordings to be made using optical recording devices.

This object will be accomplished by a generic portable stand having the features set out in the main claim 1.

Advantageous embodiments are described in the sub-claims.

A portable stand of the invention includes a slidable arrest carriage that can be locked in position, provided between a first handle and a connection plate for holding the devices to be supported and carried, on a basic body of said stand. Movably mounted on said arrest carriage is a second, turning handle which runs in ball headed bearing means. Owing to the Inventive design of the portable stand, the center of gravity of the device to be supported and carried, in particular cameras, will be stabilized in such a manner that a considerably higher inertia of the supported weight results. This allows steady and unblurred recordings to be made across all movement axes, without the need for a counterweight.

In an advantageous embodiment of the invention, the arrest carriage includes connecting means for receiving a protruding connecting element of a ball-and-socket joint, with said ball-and-socket joint running in ball-headed connection and bearing means, and it moreover includes receiving and holding means for a protruding connecting element of said second, turning handle on the side of the ball headed connection means opposite said ball-and-socket joint. This will ensure that the stand of the invention can be moved across and in all movement axes.

In another advantageous embodiment of the stand of the invention, the ball headed connection means includes a locking screw for locking the ball headed connection means in position. This allows an optimum angle to be set between the second handle and the basic body of the stand. This makes it possible to balance the different gravity centers of various devices mounted on said stand. It is possible, moreover, to balance different height settings of the second handle relative to said basic body.

In yet another advantageous embodiment of the invention, a locking sleeve for locking in position an extendable extension body guided within said basic body is provided in the area of said first handle. Said extension body will advantageously allow the length of said stand to be almost doubled, which will clearly widen the range of possible applications of said stand. In this embodiment, said first handle may be mounted on said extension body. Said basic body and said extension body are advantageously of tubular design.

In yet another advantageous embodiment of the stand of the invention, the end of said first handle facing away from said basic body and/or said extension body includes connecting means for receiving belt clip means or a support post. In this case, said belt clip means may include ball headed connection means for mounting it on said connecting means. Owing to said belt clip means, the stand of the invention can be carried for a very long time period, since the weights of said stand and of the device to be supported and carried will be optimally distributed.

In yet another advantageous embodiment of the invention, the connection plate includes a snap or bayonet catch for detachably mounting thereon the device to be supported. This will ensure swift installation of the device on the stand of the invention.

Further details, features and advantages of the invention may be gathered from an embodiment illustrated in the attached drawings, of which

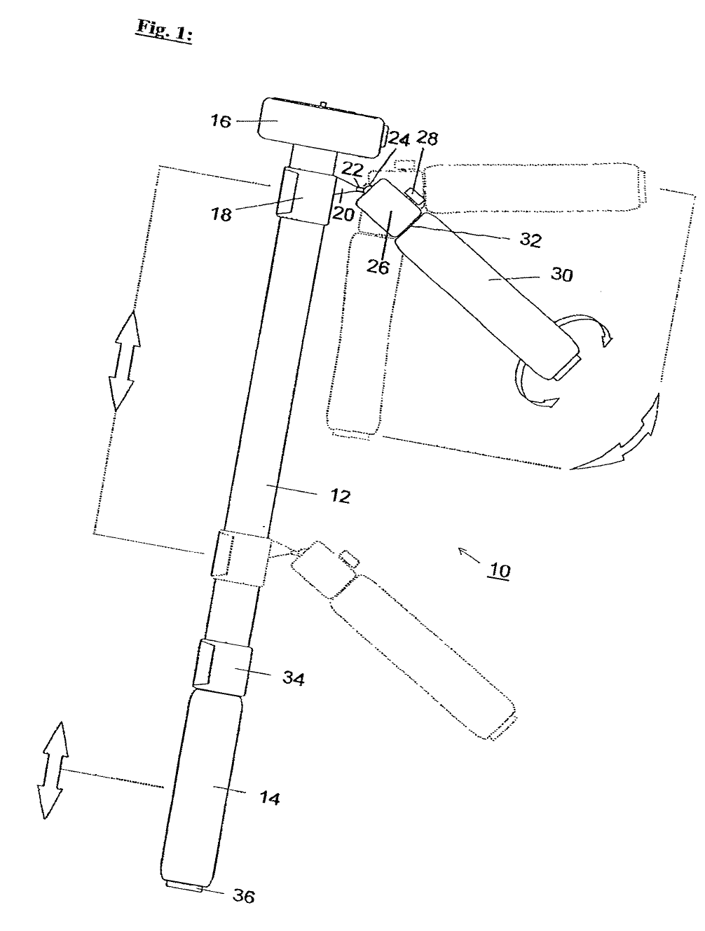

FIG. 1 is a lateral view of the portable stand of the invention.

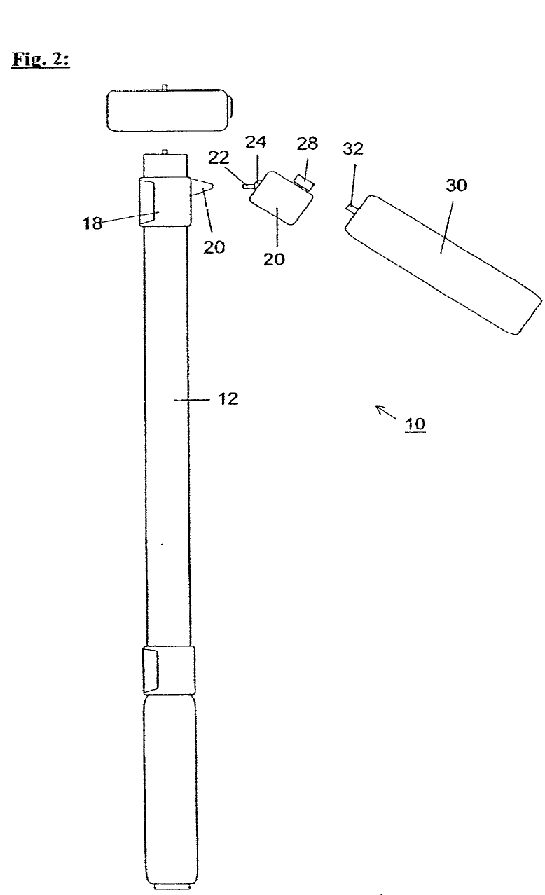

FIG. 2 is a lateral, partially exploded view of the stand of the invention.

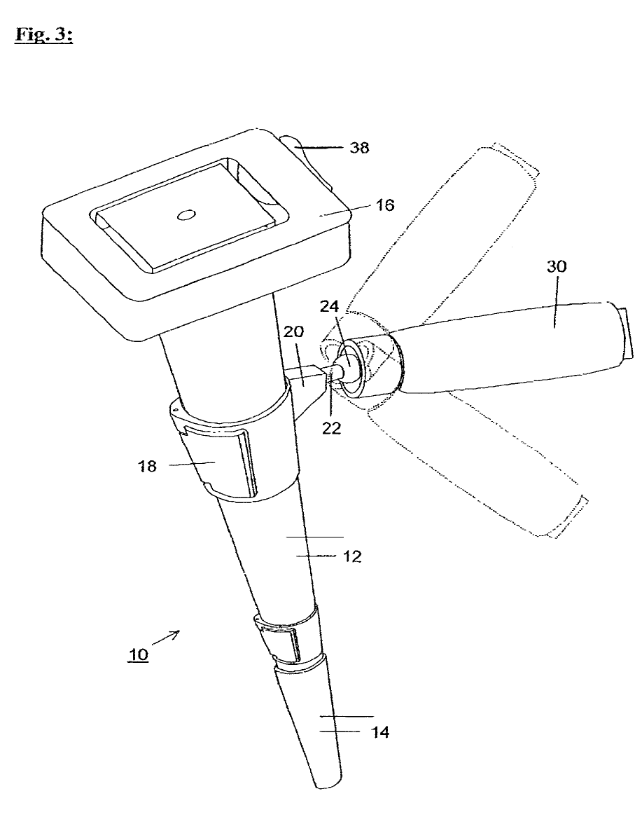

FIG. 3 is a top perspective view of the stand of the invention, and

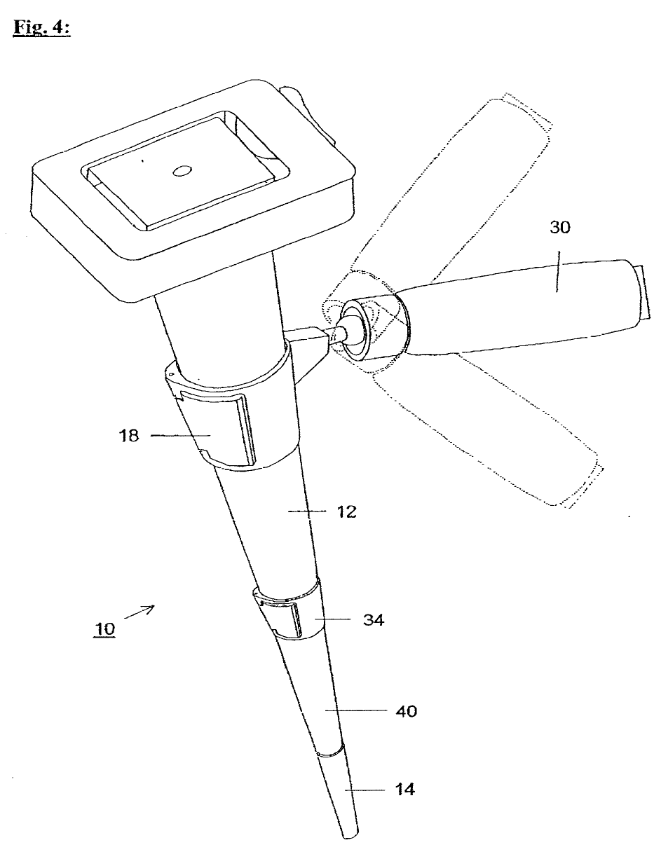

FIG. 4 is a top perspective view of the stand of the invention including an extension body.

FIG. 1 is a lateral view of the portable stand 10 including an oblong basic body 12 and a first handle 14 provided at one end of said basic body 12, as well as a connection plate 16 mounted at the opposite end of said basic body 12, for receiving the device to be supported and carried. Such devices may be video an d movie cameras, photo-cameras or other optical recording devices. It can be seen in this view that a slidable arrest carriage 18 that can be locked in position is provided on said basic body 12, between said first handle 14 and said connection plate 16. Movably mounted on said arrest carriage 18 is a second, turning handle 30 which runs in ball headed bearing means.

In this view, said arrest carriage 18 includes connecting means 20 for receiving a protruding connecting element 22 of a ball-and-socket joint 24. Said ball-and-socket joint 24 runs in ball headed bearing and connection means 26. The side of said ball headed bearing and connection means 26 opposite said ball-and-socket joint 24 is equipped to receive a protruding connecting element 32 of said second, turning handle 30. Moreover, said ball headed bearing and connection means 26 includes a locking screw 28 for locking said ball headed bearing and connection means 26 in position. It can clearly be seen in this view that said handle 30 can turn about its longitudinal axis. Moreover, said ball-and-socket joint 24 allows said second handle 30 to be moved.

It can furthermore be gathered from this drawing that a locking sleeve 34, for fixing the position of an extendable extension body 40 (cf. FIG. 4) guided within said basic body 12, is provided in the area of said first handle 14. In this view, said first handle 14 is mounted on said extension body 40. The end of said first handle 14 facing away from said basic body 12 and/or said extension body 40 moreover includes connecting means 36 equipped to receive a belt clip (not shown) or a support post (not shown). In this case, said belt clip may include ball headed connection means for attaching it to said connecting means 36.

FIG. 2 is a partially exploded lateral view of said stand 10. It shows the structure and how said second handle 30 is connected to said ball headed connection means 26 via said protruding connecting element 32. It furthermore shows how said ball headed connection means 26 is attached to said connecting means 20 of said arrest carriage 18, via said protruding connecting element 22 of said ball-and-socket joint 24.

FIG. 3 is a top perspective view of said portable stand 10. It clearly shows how said first handle 30 can be moved relative to said basic body 12 of said stand 10 by means of said ball-and-socket joint 24. Moreover, it is apparent that said basic body 12 of this embodiment is of tubular design. The connection plate 16 includes locking means 38 for mounting a camera or the like thereon. Moreover, said connection plate 16 may include a snap or bayonet catch for detachably mounting thereon the device to be supported and carried.

FIG. 4 is a top perspective view of said stand, with said extension body 40 in the extended state. It is clear from this view that both said basic body 12 and said extension body 40 of this embodiment are of tubular design. In this case, said first handle 14 is mounted on said extension body 40.

What is claimed is:

1. A portable stand, in particular a portable stand for holding and supporting video cameras, photo-cameras and other optical recording devices, having an oblong basic body and a first handle provided at one end of said basic body, as well as a connection plate provided at the respective opposite end of said basic body for holding the device to be carried and supported wherein
a slidable arrest carriage which can be locked in position is provided on said basic body, between said first handle and said connection plate, and a second, turning handle which runs in ball headed bearing means is movably mounted on said arrest carriage.

2. The portable stand as claimed in claim 1 wherein
said arrest carriage includes connecting means for receiving a protruding connecting element of a ball-and-socket joint, said ball-and-socket joint running in ball headed bearing and connection means and being equipped to receive, on the side of said ball headed bearing and connection means opposite said ball-and-socket joint, a protruding connecting element of said second, turning handle.

3. The portable stand as claimed in claims 1 or 2 wherein
said ball headed bearing and connection means includes a locking screw for locking said ball headed bearing and connection means in position.

4. The portable stand as claimed in claim 1 wherein
in the area of said first handle, a locking sleeve is provided for locking in position an extendable extension body guided within said basic body.

5. The portable stand as claimed in claim 4 wherein
the end of said first handle facing away from said basic body and/or said extension body includes connecting means for receiving a belt clip or a support post.

6. The portable stand as claimed in claim 5 wherein
said belt clip includes ball headed connection means for attaching it to said connecting means.

7. The portable stand as claimed in claim 4 wherein
said basic body and said extension body are of tubular design.

8. The portable stand as claimed in claim 1 wherein
said connection plate includes a snap or bayonet catch for detachably attaching thereto the device to be carried and supported.

9. The portable stand as claimed in claim 4 wherein
said first handle is mounted on said extension body.
